(19) United States
(12) Patent Application Publication
(10) Pub. No.: US 2019/0017300 A1
(43) Pub. Date: Jan. 17, 2019

(54) HANDLE DEVICE

(71) Applicant: HONDA MOTOR CO., LTD., Tokyo (JP)

(72) Inventors: Toyohisa Amagai, Wako-shi (JP); Kazutaka Imamura, Wako-shi (JP); Katsuya Ashizawa, Haga-machi (JP); Hiroaki Kobayashi, Haga-machi (JP)

(21) Appl. No.: 16/019,900

(22) Filed: Jun. 27, 2018

(30) Foreign Application Priority Data
Jul. 12, 2017 (JP) 2017-136417

(51) Int. Cl. E05B 79/02; E05B 85/12; E05B 53/00; E05B 79/20

(52) U.S. Cl. CPC E05B 79/02; E05B 79/20; E05B 53/005; E05B 85/12

(57) ABSTRACT

A handle device comprising: a handle base portion on which an operation handle that operates opening/closing of a door of a vehicle can be mounted; a cable portion that can be fitted in the handle base portion; and a cable holding member configured to hold the cable portion, wherein the cable holding member includes an interference portion that interferes with the cable portion in a case in which the cable portion is not located at a fitting position, and does not interfere with the cable portion in a case in which the cable portion is located at the fitting position at a time of holding.

### BACKGROUND OF THE INVENTION

### Field of the Invention

The present invention relates to a handle device such as an inner handle attached to the door panel of a vehicle door.

### Description of the Related Art

Japanese Patent No. 5607239 discloses a vehicle door device including an interference portion provided on a door panel, which interferes with a cable holding member located at a non-engaging position and avoids the interference with the cable holding member located at an engaging position in a state in which a handle device is attached to the door panel.

According to this arrangement, in a state in which the cable holding member is located at the non-engaging position, the projecting portion of the cable holding member hits the interference portion on the door panel side. Hence, it is possible to find that the cable holding member does not exist at the engaging position when attaching the handle device.

However, in the technique of Japanese Patent No. 5607239, whether a cable is appropriately attached is not taken into consideration. That is, since focus is placed only on the position of the cable holding member, the cable holding member never interferes with the interference portion as long as the cable holding member is located at the engaging position even if the cable is not appropriately attached. Hence, it may be impossible to find that attachment of the cable has been forgotten.

The present invention has been made in consideration of the above-described problem, and provides a technique for easily confirming that a cable is appropriately attached by a cable holding member.

### SUMMARY OF THE INVENTION

In order to solve the above-described problem, according to the present invention, there is provided a handle device comprising: a handle base portion on which an operation handle that operates opening/closing of a door of a vehicle can be mounted; a cable portion that can be fitted in the handle base portion; and a cable holding member configured to hold the cable portion, wherein the cable holding member includes an interference portion that interferes with the cable portion in a case in which the cable portion is not located at a fitting position, and does not interfere with the cable portion in a case in which the cable portion is located at the fitting position at a time of holding.

### BRIEF DESCRIPTION OF THE DRAWINGS

FIG. 1 is a view showing a door to which a handle device according to an embodiment is applied, which is observed from a seat in a vehicle outward direction;

FIG. 2 is a view showing the outer appearance of the handle device;

FIG. 3 is a view showing the outer appearance of the handle device observed from a back side;

FIG. 4 is an enlarged view of the handle device;

FIG. 5 is an enlarged view of a cable holding member and an interference portion;

FIG. 6 is a sectional view taken along a line A-A in FIG. 5 in a case of holding by the cable holding member; and

FIG. 7 shows a sectional view taken along a line B-B in FIG. 6 and a sectional view taken along a line C-C.

### DESCRIPTION OF THE EMBODIMENTS

An embodiment of the present invention will now be described with reference to the accompanying drawings. Note that the same reference numerals denote the same constituent elements throughout the drawings.

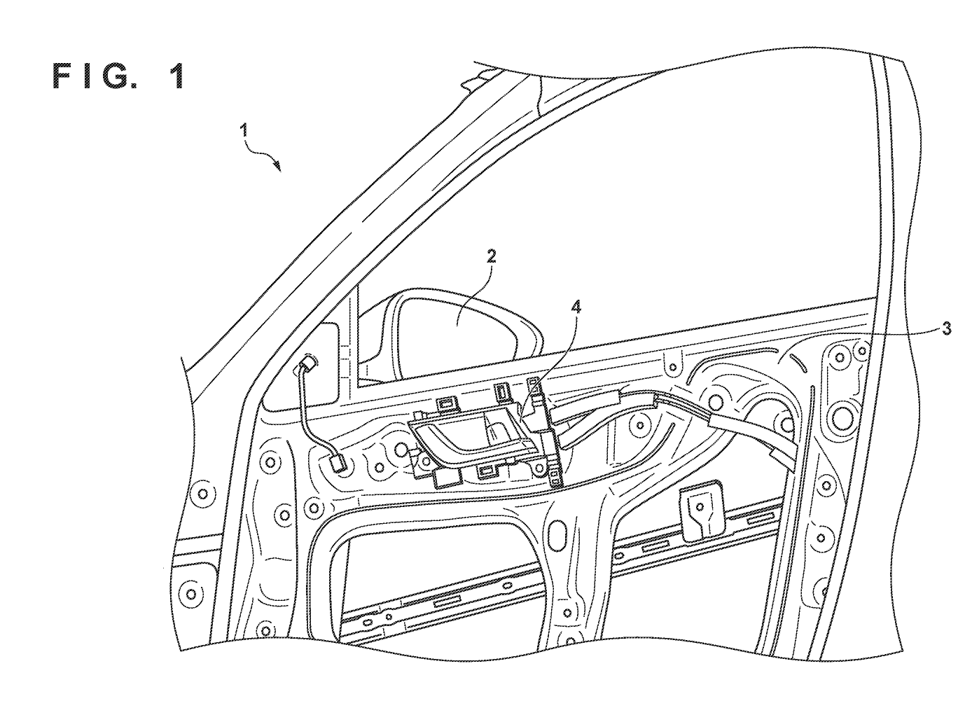

FIG. 1 is a view showing a door to which a handle device according to an embodiment of the present invention is applied, which is observed from a seat in a vehicle outward direction. Reference numeral 1 denotes a vehicle according to this embodiment; 2, a door mirror; 3, a door panel; and 4, a handle device. As for the door shown in FIG. 1, a door lining that covers the door panel 3 and interior members such as an arm rest are detached, and the door panel 3 can be observed. As the door including the handle device 4 according to this embodiment, the right front door (the door of the driver seat) of a four-wheeled vehicle is shown. However, the present invention is not limited to this, and can also be applied to the left front door (the door of the passenger seat), the right rear door, the left rear door, or a sliding door.

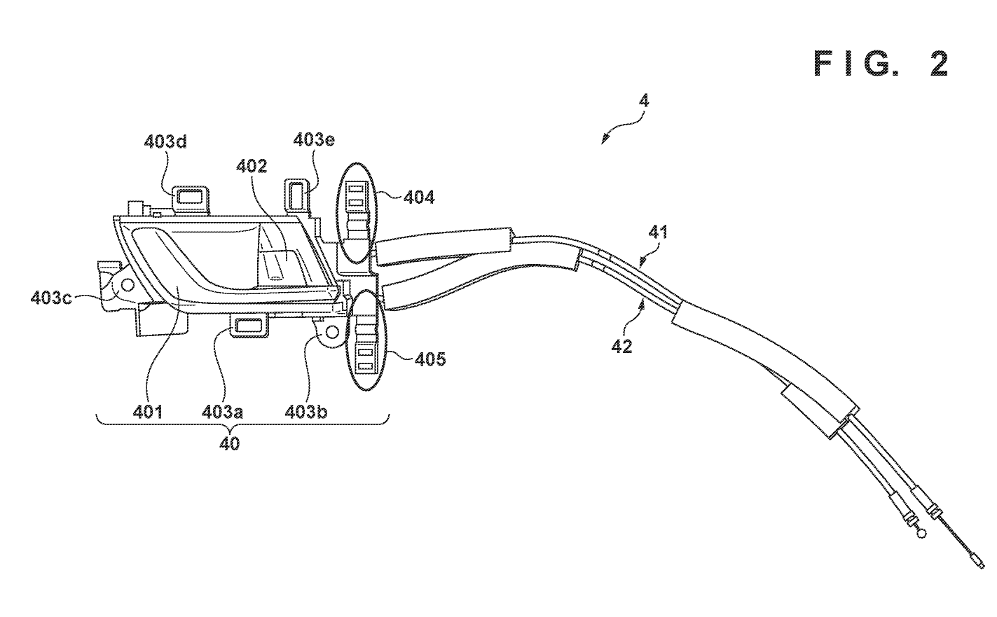

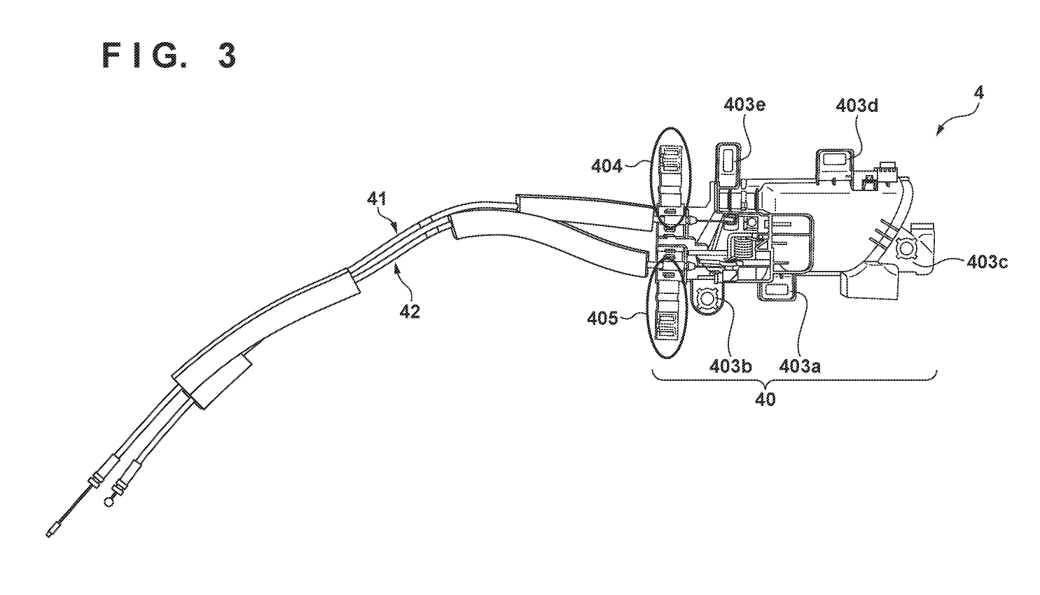

FIG. 2 is a view showing the outer appearance of the handle device according to an embodiment of the present invention. FIG. 3 is a view showing the outer appearance of the handle device shown in FIG. 2 observed from a back side. As shown in FIGS. 2 and 3, the handle device 4 includes a handle base portion 40, a lock-side cable portion 41, and a latch-side cable portion 42.

One end of the lock-side cable portion 41 can be fitted in the handle base portion 40 and is connected to a lock knob 402 to be described later. The other end of the lock-side cable portion 41 is connected to a lock device (not shown) configured to lock a latch device (not shown) that engages the door main body with the vehicle body. One end of the latch-side cable portion 42 can be fitted in the handle base portion 40 and is connected to an inner handle (operation handle) 401 to be described later. The other end of the latch-side cable portion 42 is connected to the latch device (not shown) that engages the door main body with the vehicle body.

The handle base portion 40 is a base portion on which an operation handle (for example, the inner handle 401 to be described later) that operates opening/closing of the door of the vehicle 1 can be mounted and is attached to the door panel 3. The handle base portion 40 includes the inner handle (operation handle) 401, the lock knob 402, door lining engaging portions 403a, 403d, and 403e, handle device attachment portions 403b and 403c, a lock-side cable holding member 404, and a latch-side cable holding member 405.

The inner handle 401 is an operation handle swingably attached via the shaft (not shown) of the handle base portion 40. The lock knob 402 is a lock knob swingably attached to the handle base portion 40 via a fulcrum boss (not shown) and can manually switch on/off of the lock. When the lock is on, the door is not opened even if the inner handle 401 is operated.

The door lining engaging portions 403a, 403d, and 403e are engaging portions used to attach the handle base portion 40 to a door lining (not shown). The handle device attachment portions 403b and 403c are attachment portions used to attach the handle base portion 40 to the door panel 3. However, the number of door lining engaging portions and the number of handle device attachment portions are not limited to the illustrated examples. The lock-side cable holding member 404 is a member that holds the lock-side cable portion 41. The latch-side cable holding member 405 is a member that holds the latch-side cable portion 42.

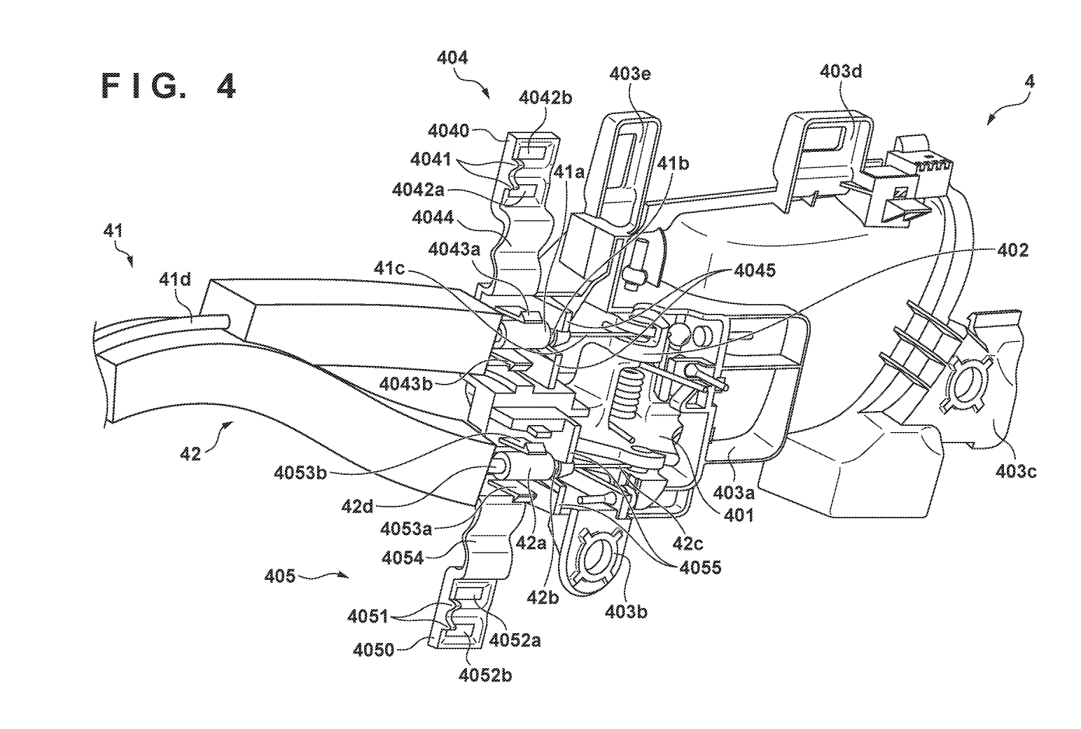

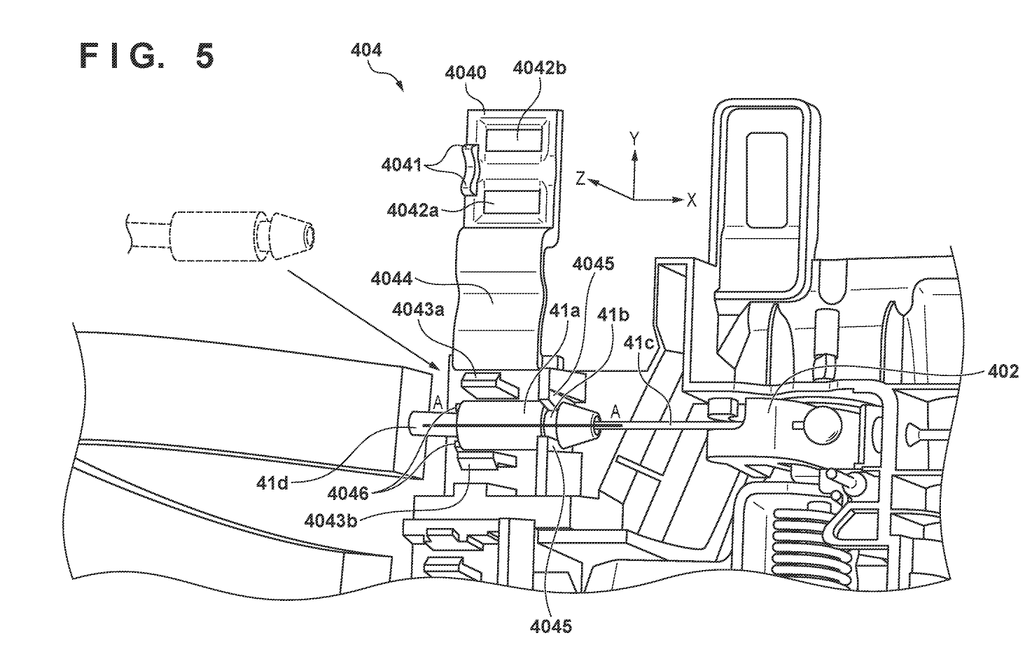

Details of the lock-side cable portion 41 and the latch-side cable portion 42, and the lock-side cable holding member 404 and the latch-side cable holding member 405 will be described next with reference to FIGS. 4 and 5. FIG. 4 is an enlarged view of the handle device. FIG. 5 is an enlarged view of a cable holding member and an interference portion.

As shown in FIGS. 4 and 5, the lock-side cable portion 41 includes a tube portion 41a held by the lock-side cable holding member 404, a fitting groove 41b formed in a part of the tube portion 41a and fitted in a lock-side fitting portion 4045 to be described later, an inner cable 41c with one end connected to the lock knob 402, and an outer tube 41d slidably including the inner cable 41c. The tube portion 41a includes a part of the outer tube 41d.

Like the lock-side cable portion 41, the latch-side cable portion 42 includes a tube portion 42a held by the latch-side cable holding member 405, a fitting groove 42b formed in a part of the tube portion 42a and fitted in a latch-side fitting portion 4055 to be described later, an inner cable 42c with one end connected to the inner handle (operation handle) 401, and an outer tube 42d slidably including the inner cable 42c. The tube portion 42a includes a part of the outer tube 42d.

The lock-side cable holding member 404 includes a lock-side abutment portion 4040, a lock-side interference portion 4041, lock-side opening portions 4042a and 4042b, lock-side engaging convex portions 4043a and 4043b, a lock-side bending portion 4044, the lock-side fitting portion 4045, and lock-side guide members 4046.

Similarly, the latch-side cable holding member 405 includes a latch-side abutment portion 4050, a latch-side interference portion 4051, latch-side opening portions 4052a and 4052b, latch-side engaging convex portions 4053a and 4053b, a latch-side bending portion 4054, and the latch-side fitting portion 4055. Although not illustrated, the latch-side cable holding member 405 also includes latch-side guide members like the lock-side guide members 4046. Since the structure of the latch-side cable holding member 405 is the same as the structure of the lock-side cable holding member 404, the lock-side cable holding member 404 will mainly be described below.

In a state in which the portion of the fitting groove 41b of the lock-side cable portion 41 is fitted in the lock-side fitting portion 4045, the lock-side abutment portion 4040 can be bent about the lock-side bending portion 4044 extending from the handle base portion 40. The lock-side abutment portion 4040 is bent about the lock-side bending portion 4044 and thus abuts against the tube portion 41a of the lock-side cable portion 41.

The lock-side interference portion 4041 is a convex portion extending from a part of the lock-side abutment portion 4040 in an abutment direction. When holding the lock-side cable portion 41 by the lock-side cable holding member 404, if the lock-side cable portion 41 is arranged at an appropriate fitting position, the lock-side interference portion 4041 does not interfere with the lock-side cable portion 41. However, if the lock-side cable portion 41 is not arranged at an appropriate fitting position, the lock-side interference portion 4041 interferes with the lock-side cable portion 41 (in particular, the tube portion 41a). When interference occurs, the lock-side abutment portion 4040 cannot abut against the tube portion 41a of the lock-side cable portion 41, the lock-side cable portion 41 cannot be held by the lock-side cable holding member 404. This makes it possible to easily confirm that the cable is appropriately attached by the cable holding member.

The lock-side opening portions 4042a and 4042b are opening portions provided in the lock-side abutment portion 4040. The lock-side engaging convex portions 4043a and 4043b are convex portions that are formed to extend from the handle base portion 40 and can engage with the lock-side opening portions 4042a and 4042b. The lock-side bending portion 4044 is a bending portion that is formed to extend from the handle base portion 40 and can be bent. The lock-side bending portion 4044 is, for example, a resin hinge. When the lock-side abutment portion 4040 is bent about the lock-side bending portion 4044, the lock-side engaging convex portions 4043a and 4043b are inserted into the lock-side opening portions 4042a and 4042b, respectively, and engage. The lock-side cable portion 41 is thus stably held.

The lock-side fitting portion 4045 is a member formed by extending from the handle base portion 40, in which the fitting groove 41b of the lock-side cable portion 41 is fitted.

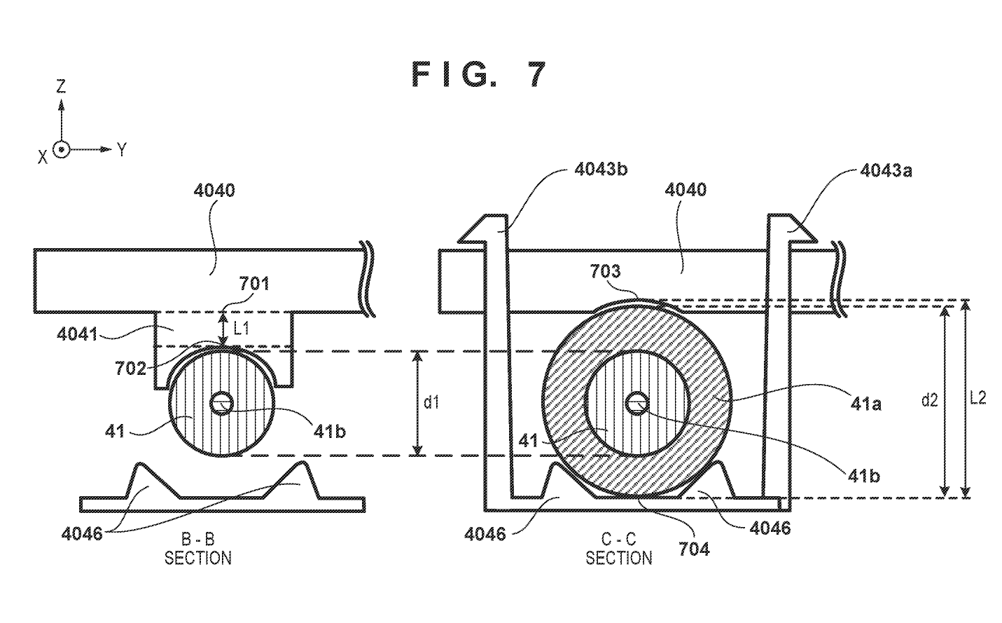

The lock-side guide members 4046 are two members formed on the handle base portion 40 along the longitudinal direction (X-axis direction) of the lock-side cable portion 41 to guide the lock-side cable portion 41 (FIG. 5 and FIG. 7 to be described later). When the lock-side guide members 4046 are arranged, it is possible to guide the tube portion 41a of the lock-side cable portion 41 to an appropriate support position, and also prevent a shift in the Y-axis direction in FIG. 5 and position the tube portion 41a.

The lock-side engaging convex portions 4043a and 4043b, the lock-side fitting portion 4045, and the lock-side guide members 4046 are formed integrally with the handle base portion 40. However, they need not always be formed integrally and may be formed on a base portion independent of the handle base portion 40, and the base portion may be connected to the handle base portion 40.

Note that as is apparent from FIGS. 1 to 5, when the handle device 4 is installed in the door (in particular, the door panel 3) of the vehicle 1, the lock-side abutment portion 4040 abuts against the lock-side cable portion 41 from the outside of the vehicle toward the inside of the vehicle 1, and the lock-side cable holding member 404 thus holds the lock-side cable portion 41. When such an arrangement configuration is employed, the lock-side cable portion 41 can be prevented from bending in the vehicle outward direction and coming into contact with the door panel 3 to which the handle device 4 is attached.

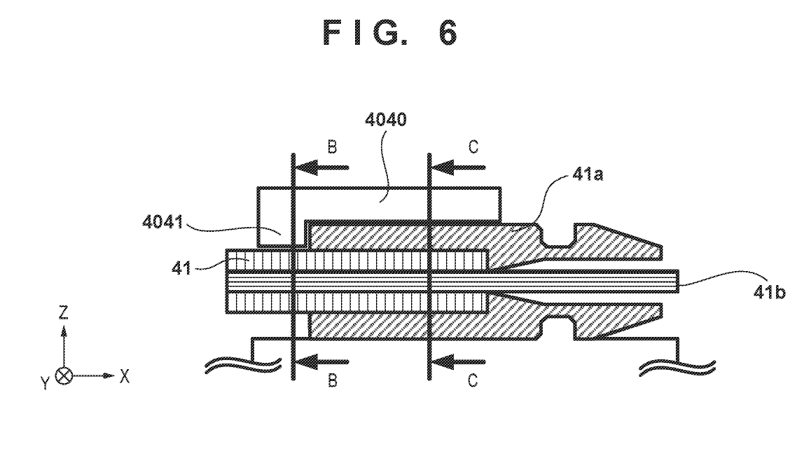

In the example shown in FIGS. 3 to 5, since the lock-side cable portion 41 is arranged at an appropriate fitting position, interference does not occur. Here, FIG. 6 is a sectional view taken along a line A-A in FIG. 5 in a state in which the lock-side cable portion 41 is held by the lock-side cable holding member 404, that is, in a state in which the lock-side abutment portion 4040 is bent about the lock-side bending portion 4044. As shown in FIG. 6, at the time of holding the lock-side cable portion 41 (at the time of bending), the lock-side interference portion 4041 never comes into contact with the lock-side cable portion 41, and interference does not occur.

On the other hand, for example, in a case in which the position of the tube portion 41a in FIG. 5 is shifted in the negative direction of the X-axis with respect to the appropriate fitting position, at the time of holding the lock-side cable portion 41 (at the time of bending), the lock-side interference portion 4041 interferes with the tube portion 41a. For this reason, the lock-side engaging convex portions 4043a and 4043b do not engage with the lock-side opening portions 4042a and 4042b, respectively, and the lock-side cable portion 41 is not held. As described above, if the lock-side cable portion 41 is not located at the appropriate fitting position, the lock-side cable holding member 404 cannot hold the lock-side cable portion 41 because of the interference of the lock-side interference portion 4041. It is therefore possible to easily notice an error at the time of assembly and improve the reliability of assembly of the handle device.

FIG. 7 shows a sectional view taken along a line B-B in FIG. 6 and a sectional view taken along a line C-C. The lock-side cable portion 41 includes a large-diameter portion (tube portion 41a) and a small-diameter portion (outer tube 41d) at different positions in the longitudinal direction. The diameter (sectional size) of the outer tube 41d is d1, and the diameter (sectional size) of the tube portion 41a is d2. On the B-B sectional view, a distance L1 from the lower surface position (point 701) of the lock-side abutment portion 4040 to the uppermost surface position (point 702) of the lock-side interference portion 4041 on the side of the outer tube 41d is the size of the lock-side interference portion 4041 in the interference direction. On the C-C sectional view, a distance L2 from the lower surface position (point 703) of the lock-side abutment portion 4040 to the bottom surface position (point 704) of the lock-side cable holding member 404 is the size of a cable holding space formed by the lock-side cable holding member 404 at a position where the lock-side interference portion 4041 does not exist.

Here, the condition that causes the lock-side interference portion 4041 to function as an interference portion is d2+L1>L2. That is, the sum of the sectional size d2 of the large-diameter portion (tube portion 41a) and the size L1 of the lock-side interference portion 4041 is larger than the size L2 of the cable holding space formed by the lock-side cable holding member 404 at the position (the position of the C-C section) where the lock-side interference portion 4041 does not exist.

If the lock-side cable portion 41 is not located at an appropriate fitting position (for example, if the lock-side cable portion 41 exists at a position in the X-axis negative direction with respect to the position in FIG. 6, that is, the lock-side cable portion 41 exists at the left position on the drawing sheet), the lock-side interference portion 4041 interferes with the large-diameter portion (tube portion 41a). Hence, the lock-side cable portion 41 cannot be held by the lock-side cable holding member 404. On the other hand, if the lock-side cable portion 41 is located at an appropriate fitting position (for example, the position in FIG. 6), the lock-side interference portion 4041 never interferes with the large-diameter portion (tube portion 41a) and abuts against the small-diameter portion (outer tube 41d). Hence, the lock-side cable portion 41 can stably be held by the lock-side cable holding member 404.

The lock-side cable holding member 404 has been described above. The latch-side cable holding member 405 also has the same arrangement as described above.

Note that the above-described embodiment is an example of the present invention, and the present invention is applicable to a correction or modification of the embodiment without departing from the scope of the present invention. The structure of the handle device according to this embodiment can be applied to any vehicle other than an automobile, as a matter of course.

For example, in the above-described embodiment, the inner handle (an operation handle that operates opening/closing of the door on the inner side of the vehicle) has been described as an example. However, the interference portion is also applicable to an outer handle (an operation handle that operates opening/closing of the door on the outer side of the vehicle).

### Summary of Embodiment

1. According to the above embodiment, there is provided a handle device (for example, 4) comprising:

a handle base portion (for example, 40) on which an operation handle (for example, 401) that operates opening/closing of a door of a vehicle (for example, 1) can be mounted;

a cable portion (for example, 41, 42) that can be fitted in the handle base portion; and

a cable holding member (for example, 404, 405) configured to hold the cable portion,

wherein the cable holding member includes an interference portion (for example, 4041, 4051) that interferes with the cable portion in a case in which the cable portion is not located at a fitting position, and does not interfere with the cable portion in a case in which the cable portion is located at the fitting position at a time of holding.

According to this embodiment, in a case in which the cable portion is not located at an appropriate position, the cable holding member cannot hold the cable portion because of the interference of the interference portion. It is therefore possible to easily notice an error at the time of assembly and improve the reliability of assembly of the handle device.

2. In the handle device (for example, 4) according to the above-described embodiment,

the cable portion (for example, 41, 42) includes a large-diameter portion (for example, 41a, 42a) and a small-diameter portion (for example, 41b, 42b) at different positions in a longitudinal direction, and

a sum of a sectional size (for example, d2) of the large-diameter portion and a size (for example, L1) of the interference portion in an interference direction is larger than a size (for example, L2) of a cable holding space formed by the cable holding member at a position (for example, C-C section) where the interference portion does not exist.

According to this embodiment, in a case in which the cable portion is not located at an appropriate position, the cable holding member cannot hold the cable portion because the interference portion interferes with the large-diameter portion of the cable portion. It is therefore possible to easily notice an error at the time of assembly and improve the reliability of assembly of the handle device.

3. In the handle device (for example, 4) according to the above-described embodiment,

in the case in which the cable portion is located at the fitting position, the interference portion (for example, 4041, 4051) of the cable holding member does not interfere with the cable portion and abuts against the small-diameter portion (for example, 41d, 42d) at the time of holding (for example, B-B section).

According to this embodiment, in a case in which the cable portion is located at an appropriate position, interference does not occur, and the interference portion abuts against the small-diameter portion (for example, 41d, 42d). Hence, the cable portion can stably be held by the cable holding member.

4. In the handle device (for example, 4) according to the above-described embodiment,

the cable portion (for example, 41, 42) includes:

an inner cable (for example, 41c, 42c);

an outer tube (for example, 41d, 42d) slidably including the inner cable; and

a tube portion (for example, 41a, 42a) including a part of the outer tube,

the tube portion corresponds to the large-diameter portion, and

the outer tube corresponds to the small-diameter portion.

According to this embodiment, in a case in which the cable portion is not located at an appropriate position, the cable holding member cannot hold the cable portion because the interference portion interferes with the tube portion of the cable portion. It is therefore possible to easily notice an error at the time of assembly and improve the reliability of assembly of the handle device.

5. In the handle device (for example, 4) according to the above-described embodiment,

the handle base portion (for example, 40) includes a fitting portion (for example, 4045, 4055) in which the cable portion can be fitted, and

a fitting groove (for example, 41b, 42b) to be fitted in the fitting portion is formed in the tube portion of the cable portion.

According to this embodiment, the cable portion can be fitted at an appropriate fitting position.

6. In the handle device (for example, 4) according to the above-described embodiment,

the cable holding member (for example, 404, 405) includes:

a bending portion (for example, 4044, 4054) extending from the handle base portion; and

an abutment portion (for example, 4040, 4050) capable of abutting against the cable portion when bent about the bending portion, and

the cable holding member holds the cable portion when the abutment portion abuts against the cable portion.

According to this embodiment, in a case in which the cable portion is located at an appropriate position, the abutment portion abuts against the cable portion, and the cable portion can thus stably be held by the cable holding member.

7. In the handle device (for example, 4) according to the above-described embodiment,

the interference portion (for example, 4041, 4051) is a convex portion extending from a part of the abutment portion (for example, 4040, 4050) in an abutment direction.

According to this embodiment, in a case in which the cable portion is not located at an appropriate position, the convex portion extending from the abutment portion interferes with the cable portion in the abutment direction, and the cable holding member cannot hold the cable portion. It is therefore possible to easily notice an error at the time of assembly and improve the reliability of assembly of the handle device.

8. In the handle device (for example, 4) according to the above-described embodiment,

when the handle device (for example, 4) is installed in the door of the vehicle (for example, 1), the cable holding member (for example, 404, 405) holds the cable portion when the abutment portion (for example, 4040, 4050) abuts against the cable portion from an outside of the vehicle toward an inside of the vehicle.

According to this embodiment, the cable portion can be prevented from bending in the vehicle outward direction and coming into contact with the door panel to which the handle device is attached.

According to the present invention, it is possible to easily confirm that the cable is appropriately attached by the cable holding member.

This application claims the benefit of Japanese Patent Application No. 2017-136417, filed Jul. 12, 2017, which is hereby incorporated by reference herein in its entirety.

What is claimed is:

1. A handle device comprising:
a handle base portion on which an operation handle that operates opening/closing of a door of a vehicle can be mounted;
a cable portion that can be fitted in the handle base portion; and
a cable holding member configured to hold the cable portion,
wherein the cable holding member includes an interference portion that interferes with the cable portion in a case in which the cable portion is not located at a fitting position, and does not interfere with the cable portion in a case in which the cable portion is located at the fitting position at a time of holding.

2. The device according to claim 1, wherein the cable portion includes a large-diameter portion and a small-diameter portion at different positions in a longitudinal direction, and
a sum of a sectional size of the large-diameter portion and a size of the interference portion in an interference direction is larger than a size of a cable holding space formed by the cable holding member at a position where the interference portion does not exist.

3. The device according to claim 2, wherein in the case in which the cable portion is located at the fitting position, the interference portion of the cable holding member does not interfere with the cable portion and abuts against the small-diameter portion at the time of holding.

4. The device according to claim 2, wherein the cable portion includes:
an inner cable;
an outer tube slidably including the inner cable; and
a tube portion including a part of the outer tube,
the tube portion corresponds to the large-diameter portion, and
the outer tube corresponds to the small-diameter portion.

5. The device according to claim 4, wherein the handle base portion includes a fitting portion in which the cable portion can be fitted, and
a fitting groove to be fitted in the fitting portion is formed in the tube portion of the cable portion.

6. The device according to claim 1, wherein the cable holding member includes:
a bending portion extending from the handle base portion; and
an abutment portion capable of abutting against the cable portion when bent about the bending portion, and
the cable holding member holds the cable portion when the abutment portion abuts against the cable portion.

7. The device according to claim 6, wherein the interference portion is a convex portion extending from a part of the abutment portion in an abutment direction.

8. The device according to claim 6, wherein when the handle device is installed in the door of the vehicle, the cable holding member holds the cable portion when the abutment portion abuts against the cable portion from an outside of the vehicle toward an inside of the vehicle.
